(19) United States
(12) Patent Application Publication
(10) Pub. No.: US 2019/0384888 A1
(43) Pub. Date: Dec. 19, 2019

(54) METHODOLOGY FOR A MODELING STARTING PROCESS OF A MICRO GAS TURBINE ENGINE

(71) Applicant: Dalian University of Technology, Dalian City (CN)

(72) Inventors: Xian DU, Dalian City (CN); Yanhua MA, Dalian City (CN); Ximing SUN, Dalian City (CN); Kai PENG, Dalian City (CN)

(21) Appl. No.: 16/462,512

(22) PCT Filed: Jun. 13, 2018
(86) PCT No.: PCT/CN2018/091091

§ 371 Date: May 20, 2019

(51) Int. Cl. G06F 17/50

(52) U.S. Cl. CPC G06F 17/5086; G06F 17/5009; F05D 2200/00; F05D 2260/81; F05D 2250/82

(57) ABSTRACT

The present invention belongs to the technical field of engine modeling, and provides a methodology for modeling a starting process of a micro gas turbine engine, comprising the following steps: modeling micro gas turbine engine speed; modeling a relationship between micro gas turbine engine performance parameters and speed; and performing error analysis. Since most existing micro gas turbine engine modeling methodologies are methodologies using pure mechanism or machine learning, it is difficult to accurately describe the starting process of a micro gas turbine engine, and machine learning requires a lot of test data. In engineering practice, pure mechanisms commonly used at present are complicated in operation, low in efficiency, and low in modeling accuracy. The invention provides a methodology for modeling a starting process of a micro gas turbine engine based on a combination of a mechanism and an identification method, which makes up for the deficiencies of the prior art. The present invention is simple in operation and high in accuracy, and can implement modeling of the whole micro gas turbine engine. The methodology has certain extensibility and can be extended to other fields.

### TECHNICAL FIELD

The present invention belongs to the technical field of engine modeling, and particularly relates to a methodology for modeling a starting process of a micro gas turbine engine.

### BACKGROUND

A micro gas turbine engine is a complex thermodynamic system consisting of a compressor, a combustor and a turbine. In the process of studying starting of the micro gas turbine engine, establishing a mathematical model below the idle speed of the micro gas turbine engine and performing numerical calculation on the starting performance can provide reference for the control of the starting process of the micro gas turbine engine. Therefore, it is very valuable to model the starting process of the micro gas turbine engine.

As for the modeling technology of micro gas turbine engines, there are few published literatures at home and abroad, and there is no related patent related to contents in this aspect. In the existing literatures, the engine starting process is usually modeled by using a support vector machine and other methods, but a large amount of engine starting process data are required by the support vector machine, and a starting model of the engine is obtained by training the input and output data. However, for a newly developed micro gas turbine engine, a fuel plan of the starting process is obtained through design parameters of the gas turbine engine in general, and the starting process of the micro gas turbine engine is completed by a manual method in order to guarantee successful starting of the gas turbine engine. There are certain limitations when the starting model of the gas turbine engine is established through experimental data obtained by manual starting and then the fuel plan of the engine starting process is further optimized by the starting model.

For micro gas turbine engines, the current starting process modeling technology has gradually failed to meet actual engineering needs. Therefore, it is a problem urgently to be solved about how to explore an effective and efficient modeling methodology suitable for engineering practice. The starting modeling technology of micro gas turbine engines also has broad research and application prospects.

### SUMMARY

To solve the problems of large data amount, low efficiency and low modeling accuracy when modeling a starting process of a gas turbine engine existing in the prior art, the present invention proposes a methodology for modeling a starting process of a micro gas turbine engine.

A methodology for modeling a starting process of a micro gas turbine engine, comprising the following steps:

First step. modeling micro gas turbine engine speed;

Second step. modeling a relationship between micro gas turbine engine performance parameters and speed;

Third step. performing error analysis.

Concrete explanation is as follows:

First step. modeling micro gas turbine engine speed;

Step 1. analyzing a starting process mechanism of a micro gas turbine engine, establishing a residual torque model of the gas turbine engine by an engine rotor effect modeling method, specifically, by a current value of an electric starter of the micro gas turbine engine and a speed value of the micro gas turbine engine, obtaining steady-state fuel amount on this basis through calculation, thus obtaining a relationship between the micro gas turbine engine fuel amount and the micro gas turbine engine speed by a linear interpolation method, and obtaining an expression between the fuel amount of the micro gas turbine engine and the speed by using a polynomial fitting method;

Step 2: according to the fuel amount in the starting process of the micro gas turbine engine and the test data of the engine speed, by comparing with the relationship between the steady-state fuel amount and the micro gas turbine engine speed established in step 1, obtaining a difference between the fuel amount in the starting process and the steady-state fuel amount;

Step 3: making the micro gas turbine engine produce an acceleration effect by the fuel amount difference obtained in step 2, and since the relationship between the fuel amount difference and the micro gas turbine engine speed is highly non-linear, fitting the relationship between the fuel amount difference and the micro gas turbine engine speed by using a piecewise linearization method;

Step 4: making the micro gas turbine engine produce an acceleration effect by the combined action of the fuel amount difference and the starter current, and obtaining the micro gas turbine engine speed by performing integration on the acceleration of the micro gas turbine engine;

Second step. modeling a relationship between micro gas turbine engine performance parameters and speed;

Step 5: obtaining a relationship between micro gas turbine engine performance parameters (compressor outlet pressure, compressor outlet temperature, combustion chamber outlet temperature, combustion chamber outlet pressure, turbine rear outlet temperature and turbine rear outlet pressure) and micro gas turbine engine speed by using the polynomial fitting method since the relationship between the micro gas turbine engine speed and the gas turbine engine performance parameters is very close;

Step 6: since using the generated polynomial to calculate the gas turbine engine performance parameters may reduce the speed of the model and may cause unstable numerical calculation as well, discretizing the polynomial, and generating a one-dimensional interpolation table, thereby being beneficial to improving the timeliness of the starting model.

Third step. performing error analysis.

The error between each performance parameter of the established micro gas turbine engine starting model and the test data is within 5%, and all performance parameters here refer to compressor outlet pressure, compressor outlet temperature, combustion chamber outlet pressure, turbine outlet pressure, turbine outlet temperature and micro gas turbine engine speed.

The present invention has the following beneficial effects that:

Since most existing micro gas turbine engine modeling methodologies are methodologies using pure mechanism or machine learning, it is difficult to accurately describe the starting process of a micro gas turbine engine, and machine learning requires a lot of test data. In engineering practice, pure mechanisms commonly used at present are complicated in operation, low in efficiency, and low in modeling accuracy. The invention provides a methodology for modeling a starting process of a micro gas turbine engine based on a combination of a mechanism and an identification method, which makes up for the deficiencies of the prior art. The present invention is simple in operation and high in accuracy, and can implement modeling of the whole micro gas turbine engine. The method has certain extensibility and can be extended to other fields.

### DESCRIPTION OF DRAWINGS

FIG. 1 is a flow chart of modeling of a micro gas turbine engine.

FIG. 2 is a diagram showing a relationship between residual torque and fuel amount.

FIG. 3 is a diagram showing a relationship between fuel amount difference and residual torque.

FIGS. 4(a)-4(f) are comparison diagrams of modeling errors of a starting process, where (a) error of compressor outlet temperature; (b) error of compressor outlet pressure; (c) error of combustion chamber outlet pressure; (d) error of turbine outlet pressure; (e) error of turbine outlet temperature; (f) error of gas turbine engine speed.

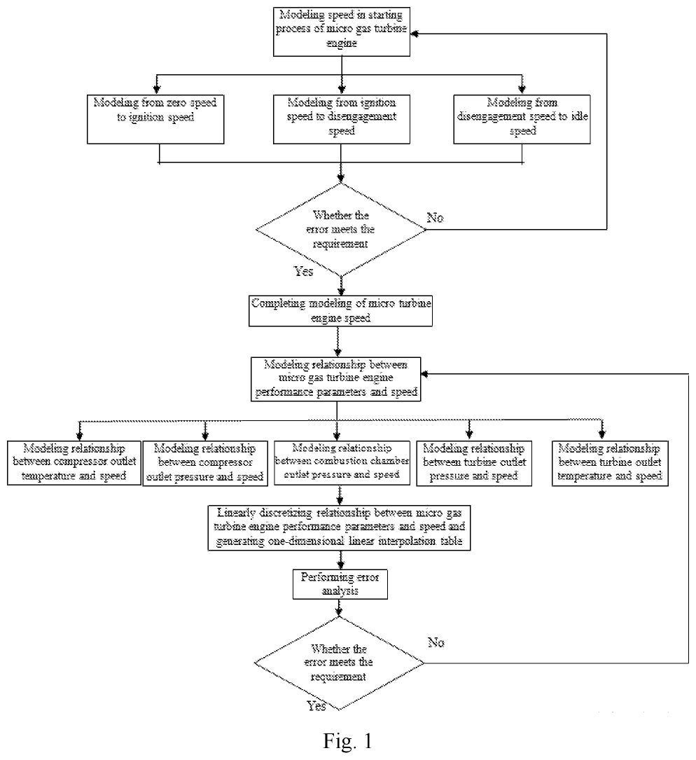

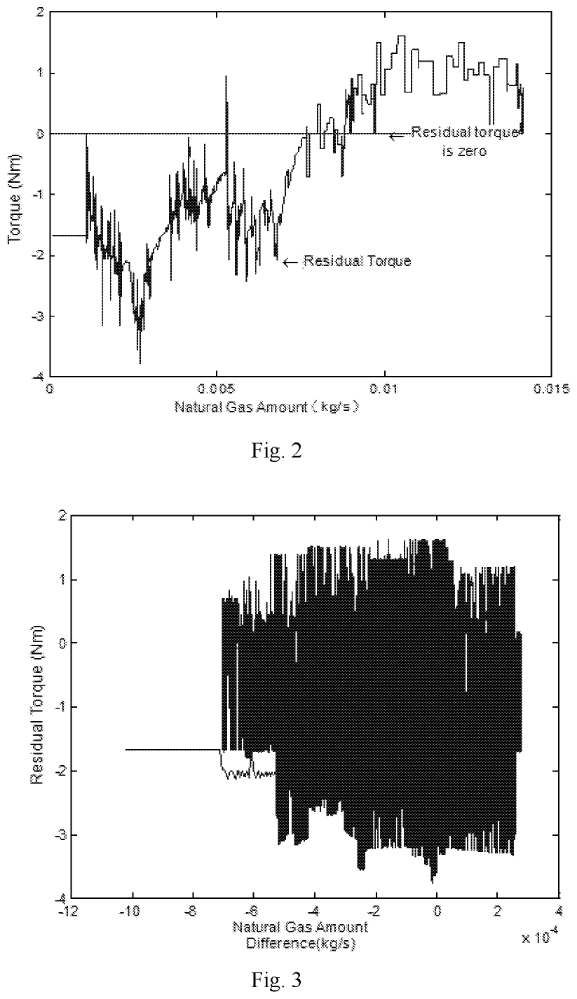

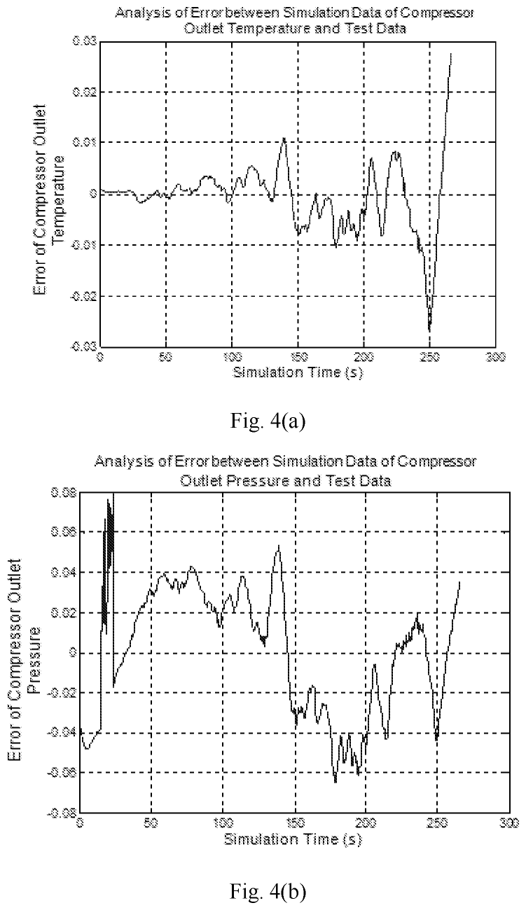

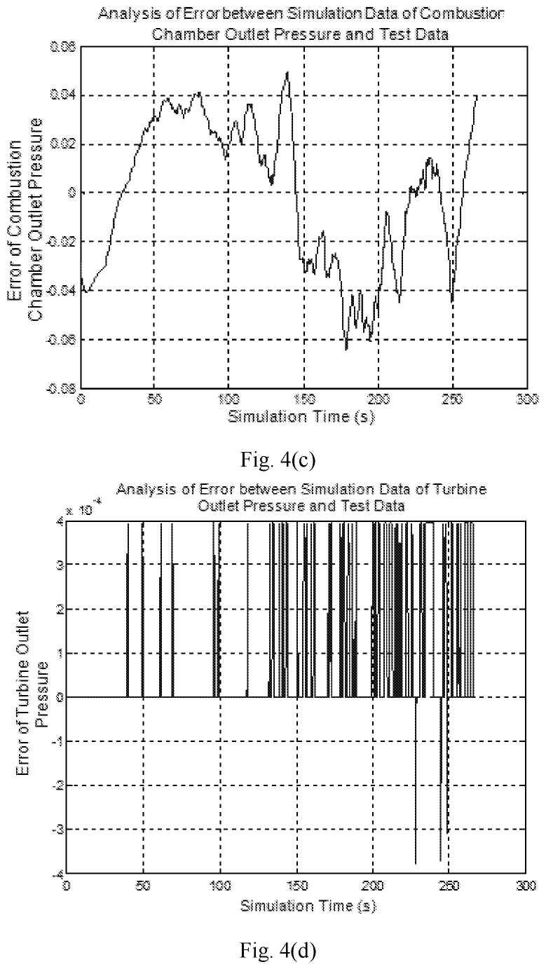

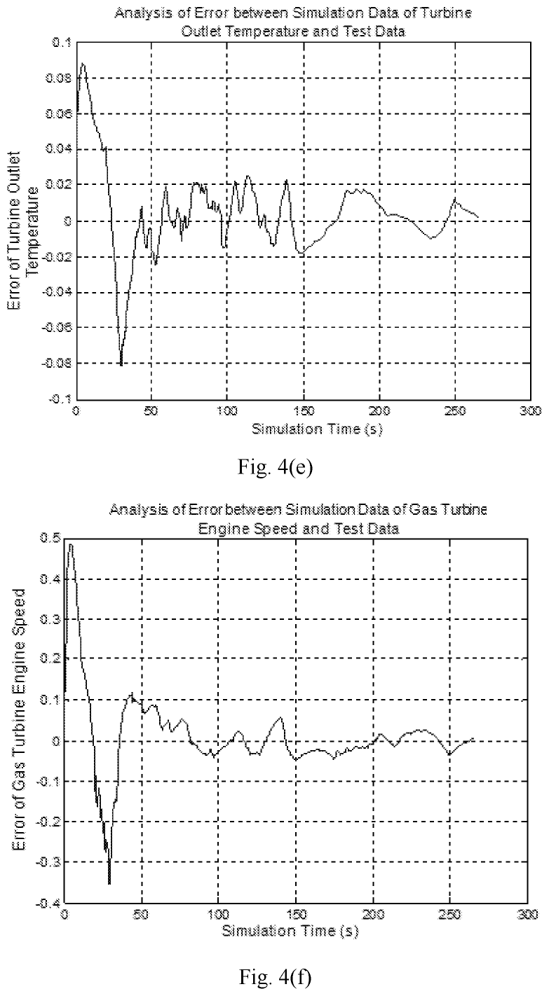

### DETAILED DESCRIPTION

To make the purpose, the technical solution and the advantages of the present invention more clear, the present invention will be further described below in detail in combination with the drawings and the examples.

A methodology for modeling a starting process of a micro gas turbine engine, comprising the following steps:

Step 1: dividing the starting process of the micro gas turbine engine into three stages: first stage, the engine speed is from zero speed to the speed at which the turbine begins to produce power, at which the engine is completely driven to accelerate by a starter; second stage, the engine speed is from the speed at which the turbine begins to produce power to starter disengagement speed; third stage, the engine speed is from the starter disengagement speed to idle speed;

modeling the starting process in accordance with each stage of the starting process of the engine;

first stage, the engine speed is from zero speed to the speed at which the turbine begins to produce power (i.e. from zero speed to ignition speed), at which the engine is completely driven to accelerate by a starter, satisfying the engine rotor motion equation, i.e. satisfying formula (1):

$$J \frac{d ω}{dt} = {M}_{st} \qquad ( 1 )$$

in the formula, Mₛₜ=Kₛₜ×Iₛₜ, where Iₛₜ represents the current value of starter, Kₛₜ represents the torque constant of the starter, for different types of starters, the values thereof are different. The starter referred here is an electric starter. ω represents the angular velocity of the micro gas turbine engine, J represents moment of the inertia reduced to the shaft of the micro gas turbine engine, i.e. equivalent moment of inertia, which is reduced by using conservation of mechanical energy for different micro gas turbine engine structures. Specific reduction formula (2) is as follows:

½×J×ω²=½×J₁×ω₁²+½×J₂×ω₂²+ . . . +½×Jₙ×ωₙ² (2)

in the formula, J₁ represents the moment of inertia of a load 1 driven by the shaft of the micro gas turbine engine, and ω₁ represents the angular velocity of the load 1 driven by the shaft of the micro gas turbine engine; J₂ represents the moment of inertia of a load 2 driven by the shaft of the micro gas turbine engine, and ω₂ represents the angular velocity of the load 2 driven by the shaft of the micro gas turbine engine; Jₙ represents the moment of inertia of a load n driven by the shaft of the micro gas turbine engine, and ωₙ represents the angular velocity of the load n driven by the shaft of the micro gas turbine engine.

Second stage, the engine speed is from ignition speed to starter disengagement speed, at which the engine is driven to accelerate by the starter and the turbine together, satisfying the engine rotor motion equation, i.e. satisfying formula (3):

$$J \frac{d ω}{dt} = {M}_{st} + {M}_{gas} \qquad ( 3 )$$

in the formula, M_{gas} represents the residual torque M_{gas}=M_{T}−M_{C}−M_{f} of the micro gas turbine engine after ignition, M_{T} represents the torque generated by the turbine, M_{C} represents the torque consumed by the compressor, which is in direct proportion to the square of the compressor speed in general, and M_{f} represents the torque consumption caused by friction, which is in direct proportion to the square of the speed in general; Mₛₜ represents the torque supplied by the electric starter, which is identical to that in formula (1). The calculation process of J is identical to that in formula (1), and ω is identical to that in formula (1).

Third stage, the engine speed is from starter disengagement speed to idle speed when the micro gas turbine engine is under the action of the residual speed, satisfying formula (4):

$$J \frac{d ω}{dt} = {M}_{gas} \qquad ( 4 )$$

in the formula, J is identical to that in formula (1), and co is identical to that in formula (1). The calculation process of M_{gas} is identical to that in formula (3).

Step 2: modeling micro gas turbine engine speed at the first stage

First, obtaining equivalent moment of inertia of the engine through calculation (see formula (2) for details); obtaining a torque value added to the shaft of the micro gas turbine engine by the starter by using the rotor motion equation in combination with the current value of the starter according to Mₛₜ=Kₛₜ×Iₛₜ through calculation, performing integration on same by using the first-order Runge-Kutta method (Euler method), to obtain the micro gas turbine engine speed of the model, and guarantee that the error between the micro gas turbine engine speed and the gas turbine engine speed in the test data is within 5%.

Step 3: modeling micro gas turbine engine speed at the second stage

Step 3.1: obtaining equivalent moment of inertia of the engine through calculation (see formula (2) for details); obtaining the residual torque of the gas turbine engine by using the rotor motion equation in combination with the current value of the starter, wherein the residual torque of the gas turbine engine=torque generated by the turbine−torque consumed by the compressor−torque caused by friction, screening all points where the absolute value of the residual torque of the gas turbine engine is zero, and according to the screened points where the absolute value of the residual torque of the gas turbine engine is zero, confirming the fuel amount corresponding to each point by using the linear interpolation method, i.e. “steady-state fuel amount” corresponding to a point;

Step 3.2: on the basis of step 3.1, performing polynomial fitting, to obtain a relational expression between the gas turbine engine speed and the steady-state fuel amount, wherein the relational expression is a ternary polynomial, specific polynomial coefficients are somewhat different since fuel types are different, the fuel adopted here is natural gas, see formula (5) for specific expression thereof:

W_{fss}=1.693×10⁻¹⁶×N_{g}³−7.637×10⁻¹²×N_{g}²+2.842×10⁻⁷×N_{g}−0.0004557 (5)

Step 3.3: since the function relationship between the residual torque of the micro gas turbine engine and the fuel amount difference is very complicated and is highly non-linear, simplifying the function relationship, describing the complicated relationship by using piecewise linear functions, provided that the relationship between the residual torque of the gas turbine engine and the fuel amount difference is a piecewise linear function relationship, i.e. describing using formula (6):

M_{gas}=k(n)×(W_{f}−W_{fss})+b(n) (6)

in the formula, k(n) and b(n) represent coefficients, for different gas turbine engine speeds, the values thereof are different, that is, the values of k(n) and b(n) represent functions of the gas turbine engine speed n, (W_{f}−W_{fss}) represents the difference between the dynamic fuel amount and the steady-state fuel amount obtained by the polynomial, for different gas turbine engine speeds, the values thereof are different;

Step 3.4: summing the residual torque of the micro gas turbine and the torque acted on the shaft of the gas turbine engine by the starter, performing integration on same by using the first-order Runge-Kutta method (Euler method), to obtain the calculated micro gas turbine engine speed of the model, and guarantee that the error between the micro gas turbine engine speed and the gas turbine engine speed in the test data is within 5%;

Step 3.5: in order to guarantee “the error between the micro gas turbine engine speed and the gas turbine engine speed in the test data is within 5%” mentioned in step 3.4, adjusting k(n) and b(n) in formula (6) in real time according to the micro gas turbine engine speed, so that the speed of the constructed micro gas turbine engine starting model is close to the test speed to a maximum extent.

Step 4: modeling micro gas turbine engine speed at the third stage

First, obtaining equivalent moment of inertia of the engine through calculation (see formula (2) for details); obtaining the torque value added to the shaft of the micro gas turbine engine by the starter by using the rotor motion equation in combination the fuel amount according to formula (6) through calculation, performing integration on same by using the first-order Runge-Kutta method (Euler method) to obtain the micro gas turbine engine speed of the model, and guarantee that the error between the micro gas turbine engine speed and the gas turbine engine speed in the test data is within 5%; adjusting k(n) and b(n) in formula (6) in real time according to the micro gas turbine engine speed, so that the speed of the constructed micro gas turbine engine starting model is close to the test speed to a maximum extent.

Step 5: since the relationship between the micro gas turbine engine performance parameters (mainly including compressor outlet temperature, compressor outlet pressure, combustion chamber outlet pressure, turbine outlet temperature and turbine outlet pressure) and the gas turbine engine speed is very close, fitting the function expression between the gas turbine engine performance parameters and the gas turbine engine speed by using a data fitting tool coming with MATLAB, that is:

T₂=K_{T}×N_{g}² (7)

in formula (7), T₂ represents compressor outlet temperature, K_{T} represents compressor outlet temperature coefficient, for different starting processes, the parameters thereof are different, and N_{g} represents micro gas turbine engine speed;

P₂=K_{P}×N_{g}² (8)

in formula (8), P₂ represents compressor outlet pressure, K_{P} represents compressor outlet pressure coefficient, for different starting processes, the parameters thereof are different, and N_{g} represents micro gas turbine engine speed;

P_{3C}=K_{c}×N_{g}² (9)

in formula (9), P_{3C} represents combustion chamber outlet pressure, K_{c} represents combustion chamber outlet pressure coefficient, for different starting processes, the parameters thereof are different, and N_{g} represents micro gas turbine engine speed;

P₄=constant+k_{wp}×N_{g} (10)

in formula (10), the turbine outlet pressure P₄ is modeled into constant value+k_{wp}×N_{g}, the constant value is 1.03 times as much as the standard atmospheric pressure, k_{wp}×N_{g} is related to the micro turbine engine speed during operation, and k_{wp} varies with the micro turbine engine speed;

T₄=Kₜ×N_{g} N_{g}∈[0,0.4×N_{gt}]

T₄=constant N_{g}∈[0.4×N_{gt},N_{idle}] (11)

in formula (11), T₄ represents turbine outlet temperature, Kₜ represents turbine outlet temperature coefficient, for different starting processes, the parameters thereof are different, N_{g} represents speed of the micro gas turbine engine, N_{gt} represents rated speed of the micro gas turbine, and N_{idle} represents idle speed of the micro gas turbine.

Step 6: linearly discretizing the obtained polynomial function relationship between the micro gas turbine engine performance parameters and speed, that is, linearly discretizing formulas (7), (8), (9), (10) and (11), wherein in order to guarantee the discretization accuracy, the step length value of the micro gas turbine engine speed is taken as 0.2%×N_{gt}, and putting the discretized data in a corresponding one-dimensional linear interpolation table.

Error analysis: according to the test data of the gas turbine engine, it is obtained that the difference between each of compressor outlet pressure, compressor outlet temperature, combustion chamber outlet pressure, turbine outlet pressure, turbine outlet temperature, micro gas turbine engine speed and the gas turbine engine starting model is within 5%, indicating that the methodology for modeling a starting process of a micro gas turbine engine proposed by the present invention is effective and feasible.

1. A methodology for modeling a starting process of a micro gas turbine engine, characterized by comprising the following steps:
step 1: dividing the starting process of the micro gas turbine engine into three stages: first stage, the engine speed is from zero speed to the speed at which the turbine begins to produce power, at which the engine is completely driven to accelerate by a starter; second stage, the engine speed is from the speed at which the turbine begins to produce power to starter disengagement speed; and third stage, the engine speed is from the starter disengagement speed to idle speed;
modeling the starting process in accordance with each stage of the starting process of the engine;
first stage, the engine speed is from zero speed to the speed at which the turbine begins to produce power, i.e. from zero speed to ignition speed, at which the engine is completely driven to accelerate by a starter, satisfying the engine rotor motion equation, i.e. satisfying formula (1):
$$J \frac{d ω}{dt} = {M}_{st} \qquad ( 1 )$$
in the formula, Mₛₜ=Kₛₜ×Iₛₜ, where Iₛₜ represents the current value of the starter, and Kₛₜ represents the torque constant of the starter; ω represents the angular velocity of the micro gas turbine engine, and J represents the moment of inertia reduced to the shaft of the micro gas turbine engine, i.e. equivalent moment of inertia, which is reduced by using conservation of mechanical energy for different micro gas turbine engine structures; specific reduction formula (2) is as follows:
½×J×ω²=½×J₁×ω₁²+½×J₂×ω₂²+ . . . +½×Jₙ×ωₙ² (2)
in the formula, J₁ represents the moment of inertia of a load 1 driven by the shaft of the micro gas turbine engine, and ω₁ represents the angular velocity of the load 1 driven by the shaft of the micro gas turbine engine; J₂ represents the moment of inertia of a load 2 driven by the shaft of the micro gas turbine engine, and ω₂ represents the angular velocity of the load 2 driven by the shaft of the micro gas turbine engine; Jₙ represents the moment of inertia of a load n driven by the shaft of the micro gas turbine engine, and ωₙ represents the angular velocity of the load n driven by the shaft of the micro gas turbine engine;
second stage, the engine speed is from ignition speed to starter disengagement speed, at which the engine is driven to accelerate by the starter and the turbine together, satisfying the engine rotor motion equation, i.e. satisfying formula (3):
$$J \frac{d ω}{dt} = {M}_{st} + {M}_{gas} \qquad ( 3 )$$
in the formula, M_{gas} represents the residual torque M_{gas} of the micro gas turbine engine after ignition, and M_{T} represents the torque generated by the turbine; M_{C} represents the torque consumed by the compressor, which is in direct proportion to the square of the compressor speed; M_{f} represents the torque consumption caused by friction, which is in direct proportion to the square of the speed; Mₛₜ represents the torque supplied by the electric starter, which is identical to that in formula (1); J is identical to that in formula (1), and ω is identical to that in formula (1);
third stage, the engine speed is from starter disengagement speed to idle speed when the micro gas turbine engine is under the action of the residual speed, satisfying formula (4):
$$J \frac{d ω}{dt} = {M}_{gas} \qquad ( 4 )$$
in the formula, J is identical to that in formula (1), ω is identical to that in formula (1); and M_{gas} is identical to that in formula (3);
step 2: modeling micro gas turbine engine speed at the first stage
first, obtaining equivalent moment of inertia of the engine through calculation, see formula (2); obtaining a torque value added to the shaft of the micro gas turbine engine by the starter by using the rotor motion equation in combination with the current value of the starter according to Mₛₜ=Kₛₜ×Iₛₜ through calculation, performing integration on same by using the first-order Runge-Kutta method, to obtain the micro gas turbine engine speed of the model, and guarantee that the error between the micro gas turbine engine speed and the gas turbine engine speed in the test data is within 5%;
step 3: modeling micro gas turbine engine speed at the second stage
step 3.1: obtaining equivalent moment of inertia of the engine through calculation, see formula (2); obtaining the residual torque of the gas turbine engine by using the rotor motion equation in combination with the current value of the starter, wherein the residual torque of the gas turbine engine=torque generated by the turbine−torque consumed by the compressor−torque caused by friction, screening all points where the absolute value of the residual torque of the gas turbine engine is zero, and according to the screened points where the absolute value of the residual torque of the gas turbine engine is zero, confirming the fuel amount corresponding to each point by using the linear interpolation method, i.e. “steady-state fuel amount” corresponding to a point;
step 3.2: on the basis of step 3.1, performing polynomial fitting, to obtain a relational expression between the gas turbine engine speed and the steady-state fuel amount, wherein the relational expression is a ternary polynomial, expression (5) is as follows:
W_{fss}=1.693×10⁻¹⁶×N_{g}³−7.637×10⁻¹²×N_{g}²+2.842×10⁻⁷×N_{g}−0.0004557 (5)
step 3.3: since the function relationship between the residual torque of the micro gas turbine engine and the fuel amount difference is very complicated and is highly non-linear, simplifying the function relationship, thus describing the complicated relationship by using piecewise linear functions, provided that the relationship between the residual torque of the gas turbine engine and the fuel amount difference is a piecewise linear function relationship, i.e. simplifying using formula (6):
M_{gas}=k(n)×(W_{f}−W_{fss})+b(n) (3)
in the formula, k(n) and b(n) represent coefficients, for different gas turbine engine speeds, the values thereof are different, that is, the values of k(n) and b(n) represent functions of the gas turbine engine speed n, (W_{f}−W_{fss}) represents the difference between the dynamic fuel amount and the steady-state fuel amount obtained by the polynomial, for different gas turbine engine speeds, the values thereof are different;
step 3.4: summing the residual torque of the micro gas turbine engine and the torque acted on the shaft of the gas turbine engine by the starter, performing integration on same by using the first-order Runge-Kutta method, to obtain the calculated micro gas turbine engine speed of the model, and guarantee that the error between the micro gas turbine engine speed and the gas turbine engine speed in the test data is within 5%;
step 3.5: in order to guarantee “the error between the micro gas turbine engine speed and the gas turbine engine speed in the test data is within 5%” mentioned in step 3.4, adjusting k(n) and b(n) in formula (6) in real time according to the micro gas turbine engine speed, so that the speed of the constructed micro gas turbine engine starting model is close to the actual test speed to a maximum extent;
step 4: modeling micro gas turbine engine speed at the third stage
first, obtaining the equivalent moment of inertia of the engine through calculation, see formula (2); obtaining the torque value added to the shaft of the micro gas turbine engine by the starter by using the rotor motion equation in combination with the fuel amount according to formula (6) through calculation, performing integration on same by using the first-order Runge-Kutta method to obtain the micro gas turbine engine speed of the model, and guarantee that the error between the micro gas turbine engine speed and the gas turbine engine speed in the test data is within 5%; adjusting k(n) and b(n) in formula (6) in real time according to the micro gas turbine engine speed, so that the speed of the constructed micro gas turbine engine starting model is close to the actual test speed to a maximum extent;
step 5: since the relationship between the micro gas turbine engine performance parameters (including compressor outlet temperature, compressor outlet pressure, combustion chamber outlet pressure, turbine outlet temperature and turbine outlet pressure) and the gas turbine engine speed is very close, fitting the function expression between the gas turbine engine performance parameters and the gas turbine engine speed, that is:
T₂=K_{T}×N_{g}² (7)
in formula (7), T₂ represents compressor outlet temperature, K_{T} represents compressor outlet temperature coefficient, for different starting processes, the parameters thereof are different, and N_{g} represents micro gas turbine engine speed;
P₂=Kₚ×N_{g}² (8)
in formula (8), P₂ represents compressor outlet pressure, K_{P} represents compressor outlet pressure coefficient, for different starting processes, the parameters thereof are different, and N_{g} represents micro gas turbine engine speed;
P_{3C}=K_{c}×N_{g}² (9)
in formula (9), P_{3C} represents combustion chamber outlet pressure, K_{c} represents combustion chamber outlet pressure coefficient, for different starting processes, the parameters thereof are different, and N_{g} represents micro gas turbine engine speed;
P₄=constant+k_{wp}×N_{g} (10)
in formula (10), the turbine outlet pressure P₄ is modeled into constant value+k_{wp}×N_{g}, the constant value is 1.03 times as much as the standard atmospheric pressure, k_{wp}×N_{g} is related to micro turbine engine speed during operation, and k_{wp} varies with the micro turbine engine speed;
T₄=Kₜ×N_{g} N_{g}∈[0,0.4×N_{gt}]
T₄=constant N_{g}∈[0.4×N_{gt},N_{idle}] (11)
in formula (11), T₄ represents turbine outlet temperature, K₁ represents turbine outlet temperature coefficient, for different starting processes, the parameters thereof are different, N_{g} represents speed of the micro gas turbine engine, N_{gt} represents rated speed of the micro gas turbine engine, and N_{idle} represents idle speed of the micro gas turbine engine;
step 6: linearly discretizing the obtained polynomial function relationship between the micro gas turbine engine performance parameters and speed, that is, linearly discretizing formulas (7), (8), (9), (10) and (11), wherein in order to guarantee the discretization accuracy, the step length value of the micro gas turbine engine speed is taken as 0.2%×N_{gt}, and putting the discretized data in a corresponding one-dimensional linear interpolation table.
